(19) United States
(12) Patent Application Publication
(10) Pub. No.: US 2005/0240448 A1
(43) Pub. Date: Oct. 27, 2005

(54) System and method for insuring an entity against tenant default with respect to an income-producing property

(76) Inventor: Jeffrey C. Smith, Fairhope, AL (US)

Correspondence Address: ALSTON & BIRD LLP;BANK OF AMERICA PLAZA, 101 SOUTH TRYON STREET, SUITE 4000, CHARLOTTE, NC, 28280-4000, US

(21) Appl. No.: 10/890,457

(22) Filed: Jul. 13, 2004

Related U.S. Application Data
(60) Provisional application No. 60/565,554, filed on Apr. 27, 2004.

(51) Int. Cl. G06F 17/60

(52) U.S. Cl. 705/4

(57) ABSTRACT

According to one aspect of the present invention, a method is provided for insuring an entity with respect to an income-producing property including at least one tenant paying rent to the entity. In accordance with the method of this aspect, a policy is provided to an entity, where the policy defines a default of at least one tenant of the property based upon a financial inability of at least one tenant to pay rent to the entity. The entity can then be insured under the policy, where the entity is insured against loss of a income due to default of at least one tenant of the property. Additionally, the entity be a buyer arrangement engaged in a communication with a seller arrangement regarding the property. In such instances, the buyer arrangement can be insured after the parties conclude a real estate transaction involving the property.

### CROSS-REFERENCE TO RELATED APPLICATIONS

The present application claims priority from U.S. Provisional Patent Application Ser. No. 60/565,554, entitled: SYSTEM, METHOD AND COMPUTER PROGRAM PRODUCT FOR FACILITATING REAL ESTATE TRANSACTIONS, filed on Apr. 27, 2004, the contents of which are incorporated herein by reference in its entirety.

### FIELD OF THE INVENTION

The present invention generally relates to systems and methods for insuring income-producing property and, more particularly, to systems and methods for insuring a party against tenant default of an income-producing property.

### BACKGROUND OF THE INVENTION

In the commercial real estate industry, potential sellers of commercial real estate often avoid publicly advertising or listing their real estate, and potential buyers are often very cautious about purchasing commercial real estate that has existing tenants. Potential sellers often fear that existing tenants of affected properties will look to lease space elsewhere, and/or that potential tenants will avoid leasing space within the affected properties. Potential buyers, on the other hand, are typically reluctant to purchase property due to the risk of default of tenants leasing space within the property.

In addition, potential sellers typically prefer to not be “shopped” by competitors, or felt out by numerous developers and/or potential buyers. Further, potential sellers typically prefer to not be limited by listing agreements or agency relationships that bind the potential sellers to a single brokerage firm or an unnecessary agency liability for a specific duration. And as a result of potential sellers avoiding public advertising or listing of their properties, in various segments of commercial real estate, the demand of available potential buyers may significantly outnumber the supply of known, publicly available properties. However, this generally does not reflect the fact that the demand of available potential buyers significantly outnumbers the supply of properties available for purchase, only that a significant number of available properties may not be publicly available, and thus known to potential buyers.

### SUMMARY OF THE INVENTION

In light of the foregoing background, embodiments of the present invention provide an improved system and method for insuring an entity with respect to an income-producing property that includes at least one tenant expected to pay rent to the party. The system and method of embodiments of the present invention are capable of providing a policy, and thereafter insuring the entity under the policy against loss of income due to default of one or more tenants of the property. In this regard, the entity may be more assuredly guaranteed of an income from the property. In addition, when the entity is a buyer in a potential real estate transaction involving the property, by insuring the buyer against loss of income due to tenant default of the property, the system and method of embodiments of the present invention can facilitate the buyer and seller concluding a transaction for the property.

According to one aspect of the present invention, a method is provided for insuring an entity, such as a buyer arrangement, with respect to an income-producing property including at least one tenant paying rent to the entity. In accordance with the method of this aspect, a policy is provided to an entity, where the policy defines a default of at least one tenant of the property based upon a financial inability of at least one tenant to pay rent to the entity. In addition, the policy can define a level of protection that has been determined based upon a percentage of an income, such as a net operating income (NOI), received by the entity from the property. Then, after providing the policy, the entity can then be insured under the policy, where the entity is insured against loss of a income due to default of at least one tenant of the property.

More particularly, the entity can be insured by determining a policy benefit, and thereafter remitting the policy benefit to the entity, both occurring if a tenant defaults under the policy. In this regard, the policy benefit can be determined based upon a rental income due the entity from the defaulting tenant. For example, the policy benefit can be determined based upon an income (e.g., NOI) due the entity from the property before the tenant defaults, and an income due the entity from the property after the tenant defaults. In such an instance, the income due the entity from the property before and after the tenant defaults is at least partially based upon the rental income due the entity from the defaulting tenant.

When the entity comprises a buyer arrangement, the method can further include engaging an initiating party in communication with an initiated party regarding the property. In such an instance, the initiating party can comprise the buyer arrangement (i.e., entity) or a seller arrangement, with the initiated party being the other of the buyer arrangement and the seller arrangement. Then, after the parties conclude a real estate transaction regarding the property, the policy can be provided to the buyer arrangement and the buyer arrangement can be insured. After engaging the parties, the engaged parties are restricted from communicating with other parties during the engagement period, the other parties being at least one other buyer arrangement and/or at least one other seller arrangement. As explained below, the engaged parties can be restricted from communicating with other parties in a number of different manners. Irrespective of how the parties are restricted from communicating with other parties, however, restricting the parties advantageously facilitates the parties concluding a real estate transaction regarding the property.

More particularly, a buyer listing and/or a property listing can be provided, where the buyer listing includes at least one buyer arrangement, and the property listing includes at least one property of at least one seller arrangement. In such instances, one of the listings includes the initiating party and the other listing includes the initiated party. The engaged parties can then be restricted by from communicating with other parties by restricting access to the initiating party in the respective listing including the initiating party, and restricting access to the initiated party in the respective listing including the initiated party.

According to other aspects of the present invention, a system and an insurance system are provided for insuring an entity with respect to an income-producing property. Therefore, embodiments of the present invention provide an improved system and method for insuring an entity with respect to an income-producing property. By providing a policy and thereafter insuring the entity under the policy against loss of income due to default of one or more tenants of the property, embodiments of the present invention can facilitate the entity being more assuredly guaranteed of an income from the property. In addition, when the entity is a buyer in a potential real estate transaction involving the property, embodiments of the present invention can facilitate the buyer and seller concluding a transaction for the property, particularly since potential buyers are typically reluctant to purchase property due to the risk of default of tenants leasing space within the property Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a system for facilitating real estate transactions in accordance with embodiments of the present invention;

FIG. 2 is a schematic block diagram of an entity capable of operating as a buyer, seller and/or facilitator, in accordance with embodiments of the present invention;

FIGS. 3A and 3B are flowcharts illustrating various steps in a method of facilitating a real estate transaction in accordance with an embodiment of the present invention;

FIG. 4 is a flowchart illustrating various steps in a method of insuring the owner or leaseholder of income-producing property against the default of one or more tenants of such property, in accordance with an embodiment of the present invention; and

FIGS. 5-18 illustrate exemplar displays capable of being provided by a facilitator arrangement to buyer arrangements and seller arrangements, in accordance with embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

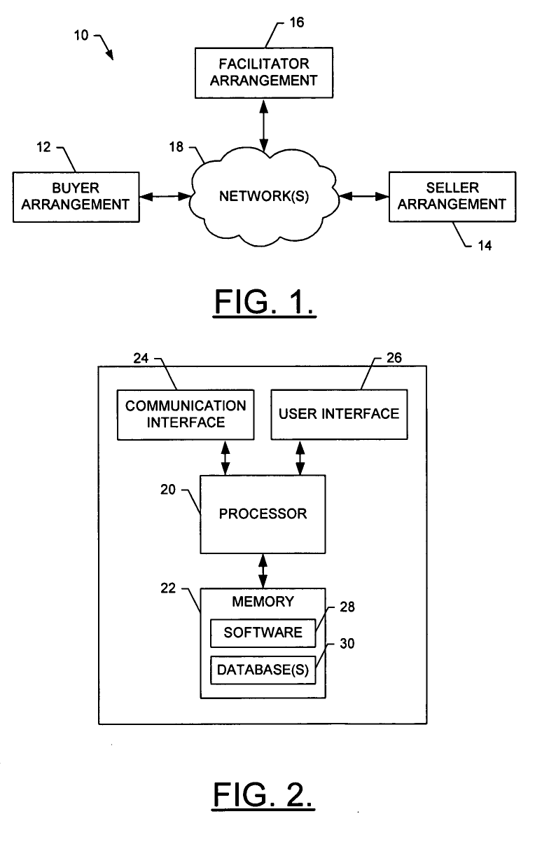

Referring to FIG. 1, a system 10 for facilitating real estate transactions includes one or more buyer arrangements 12, seller arrangements 14 and facilitator arrangements 16 (one of each being shown). Each buyer arrangement is capable of directly and/or indirectly communicating with one or more seller arrangements and facilitator arrangements. Similarly, each seller arrangement is capable of directly and/or indirectly communicating with one or more buyer arrangements and facilitator arrangements; and each facilitator arrangement is capable of directly and/or indirectly communicating with one or more buyer arrangements and seller arrangements. In this regard, the buyer, seller and facilitator arrangements can be capable of directly and/or indirectly communicating with one another across one or more networks 18. The network(s) can comprise any of a number of different combinations of one or more different types of networks. For example, the network(s) can include one or more data networks, such as a local area network (LAN), a metropolitan area network (MAN), and/or a wide area network (WAN) (e.g., Internet), and include one or more wireline and/or wireless voice networks, including a wireline network such as a public-switched telephone network (PSTN), and/or wireless networks such as IS-136 (TDMA), GSM, and/or IS-95 (CDMA). For purposes of illustration, however, as described below, the network comprises the Internet (i.e., WAN) unless otherwise noted.

The buyer arrangement 12, seller arrangement 14 and facilitator arrangement 16 can comprise any one or more of a number of different entities, devices or the like capable of operating in accordance with embodiments of the present invention. In this regard, one or more of the buyer arrangement, seller arrangement and facilitator arrangement can comprise, include or be embodied in one or more processing elements, such as one or more of a laptop computer, desktop computer, server computer or the like. Additionally or alternatively, one or more of the buyer arrangement, seller arrangement and facilitator arrangement can comprise, include or be embodied in one or more portable electronic devices, such as one or more of a mobile telephone, portable digital assistant (PDA), pager or the like. For example, the buyer arrangement, seller arrangement and facilitator arrangement can each comprise a processing element capable of communicating with one another across the Internet (e.g., network 18).

It should be understood, however, that one or more of the buyer arrangement 12, seller arrangement 14 and facilitator arrangement 16 can comprise or otherwise be associated with a user carrying out the functions of the respective entity. For example, the buyer arrangement can comprise a buyer or buyer agent (representing a buyer) communicating across a PSTN (e.g., network 18), by mail or in person with a seller operating a seller processing element, where the seller and processing element collectively comprise the seller arrangement. In such instances, the facilitator arrangement can comprise a facilitator processing element communicating across the Internet with the seller processing element. Alternatively, in such instances, the facilitator can comprise a facilitator operating a facilitator processing element, where the facilitator is capable of communicating with the seller across a PSTN. As explained below, then, the term “buyer arrangement” can refer to a buyer and/or buyer processor. Similarly, the term “seller arrangement” can refer to a seller and/or seller processor; and the term “facilitator arrangement” can refer to a facilitator and/or facilitator processor.

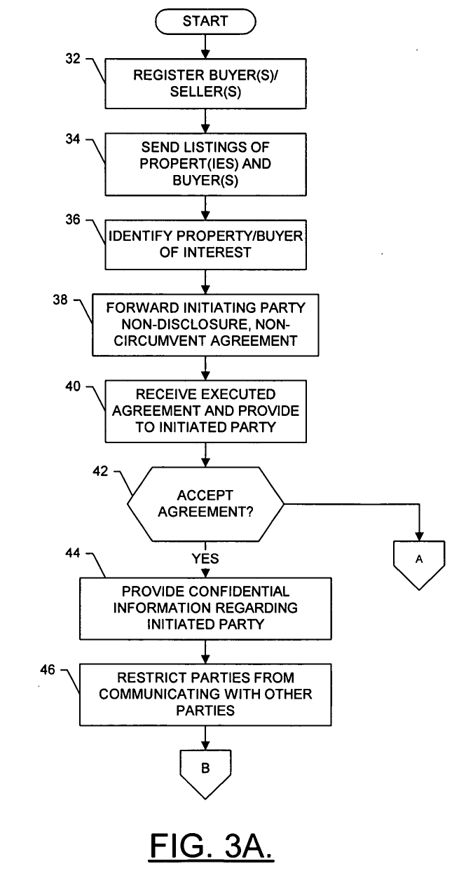

Referring now to FIG. 2, a block diagram of an entity capable of operating as a buyer arrangement 10, seller arrangement 14 and/or facilitator arrangement 16 is shown in accordance with one embodiment of the present invention. Although shown as separate entities, in some embodiments, one or more entities may support one or more of a buyer arrangement, seller arrangement and/or facilitator arrangement, logically separated but co-located within the entit(ies). For example, a single entity may support a logically separate, but co-located, buyer arrangement and facilitator arrangement. Also, for example, a single entity may support a logically separate, but co-located seller arrangement and facilitator arrangement.

As shown, the entity capable of operating as a buyer arrangement 12, seller arrangement 14 and/or facilitator arrangement 16 can generally include a processor 20 connected to a memory 22. The processor can also be connected to at least one communication interface 24 or other means for transmitting and/or receiving data, content or the like. The processor can additionally be connected to a user interface 26 that can include a display and a user input interface. The user input interface, in turn, can comprise any of a number of devices allowing the entity to receive data from a user, such as a keypad, a touch display (not shown) or other input device.

The memory 30 can comprise volatile and/or non-volatile memory, and typically stores content, data or the like. In this regard, the memory typically stores software applications 28, instructions or the like for the processor to perform steps associated with operation of the entity in accordance with embodiments of the present invention. For example, the memory can store software applications such as one or more connectivity applications (e.g., Web browser, etc.). Also, when the entity comprises a facilitator arrangement 16, the memory can store one or more databases 38, such as a buyer database and a property database. The buyer database can store information relating to buyers registered with the service offered by the facilitator arrangement, and the property database can store information relating to sellers and associated properties that are registered with the service.

In accordance with embodiments of the present invention, the facilitator arrangement 16 is capable of offering a real estate information exchange service to one or more buyer arrangements 12 and seller arrangements 14. Generally, the service provides a medium for buyers and sellers to communicate with one another without outside interference to facilitate the respective arrangements concluding a real estate sales or exchange transaction. And since buyers are typically reluctant to purchase property due to the risk of default of tenants leasing space within the property, if so desired, the service can also provide, for a period of time, insurance to the buyer against loss of income due to default of the existing tenants of the property, should a buyer and seller conclude the purchase/sale of a property. As described herein, such insurance may be referred to as “tenant default insurance.”

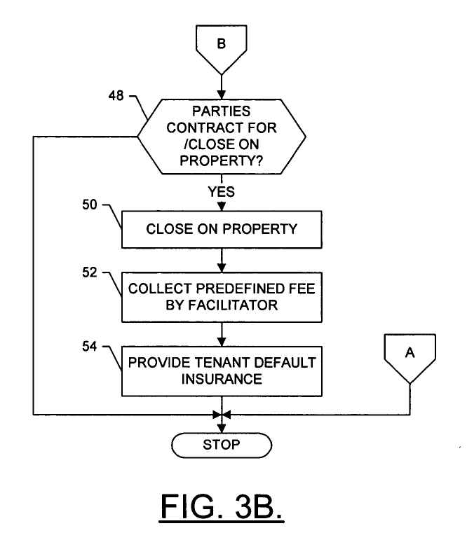

Reference is now made to FIGS. 3A and 3B, which illustrates various steps in a method of facilitating a real estate transaction, in accordance with one embodiment of the present invention. As shown in block 32, the method can include the one or more buyers and sellers of the buyer arrangements 12 and seller arrangements 14, respectively, registering with the facilitator arrangement 16, or more particularly with the service offered by the facilitator arrangement. Advantageously for the sellers, during the registration process of the buyers, information regarding the buyers can be generated, gathered or otherwise received by the facilitator arrangement. For example, the facilitator arrangement can gather information regarding property purchases made by the buyer arrangements over a previous period of time (e.g., previous 12-24 months). The facilitator arrangement can then evaluate such buyer information to determine if the buyer information is accurate to thereby determine if the buyers are legitimate. For example, the facilitator arrangement can evaluate information regarding property purchases made by the buyer to determine the nature of the financing used to purchase the properties (e.g., all cash, mortgage, owner financing, equity trade, etc.). In addition, the facilitator arrangement can evaluate the buyer information to determine if the buyers are qualified to purchase an indicated level of real estate. In this regard, if the facilitator arrangement fails to determine that the buyers are legitimate and qualified, the facilitator arrangement can refuse to register the respective buyers. Otherwise, the facilitator arrangement can register the buyers with the service offered by the facilitator arrangement.

For the buyers, information regarding the properties of the sellers and/or the sellers themselves can be generated, gathered or otherwise received by the facilitator arrangement 16. The facilitator arrangement can then evaluate such seller information to allow the facilitator arrangement to provide data related to the properties. For example, the facilitator can receive and thereafter evaluate or otherwise confirm seller information including blueprints, aerial photos, zoning, certificates of occupancy, various regulatory approval letters, rent rolls, parking ratios, setbacks, surveys, inspections, NOI's (net operating incomes), cap (capitalization) rates, financing packages, cash on cash projections, cash flow projections, comparables by radius, competition reports with tenant mix and local trend reports, as well as property specific mapping of income, population, consumer expenditure, retail sales and crime statistics.

Before, after or as the facilitator arrangement 16 evaluates the buyer information or seller information, the facilitator arrangement can create an entry for the buyer or the seller in the buyer database or property database. Also, in accordance with the service provided by the facilitator arrangement, the facilitator arrangement can send the buyer arrangements 12 listings of the properties of sellers stored in the property database, and send the seller arrangements 14 listings of buyers stored in the buyer database, as shown in block 34. The listings of properties and buyers can include any of a number of different pieces of seller information and buyer information, respectively. In one typical embodiment, for example, the listings of properties and buyers include a portion of the seller and buyer information sufficient to allow the buyers and sellers to gauge an interest in one or more properties of the sellers or one or more buyers, respectively. To facilitate the buyers and sellers engaging the service of the facilitator arrangement, however, the listings may not include information sufficient to permit the buyers or sellers to contact one another independent of the service.

After receiving the respective listings at the buyer arrangements 12 and seller arrangements 14, the buyers can identify properties of interest, and the sellers can identify buyer arrangements of interest, as shown in block 36. If either a buyer or seller (i.e., the initiating party) desires to contact a seller or buyer (i.e., the initiated party), directly or as a result of actions of the facilitator arrangement, the facilitator arrangement can forward the initiating party arrangement a non-disclosure, non-circumvent facilitation agreement in which the initiating party agrees to pay the facilitator arrangement a predefined fee for the service provided by the facilitator arrangement should the initiating party and initiated party conclude a real estate transaction with one another, as shown in block 38.

After the initiating party (i.e., buyer or seller) executes the non-disclosure, non-circumvent facilitation agreement, and the initiating party arrangement (i.e., buyer arrangement 12 or seller arrangement 14) returns the executed agreement to the facilitator arrangement 16, the facilitator arrangement can forward the agreement to the initiated party arrangement (i.e., seller arrangement or buyer arrangement) for acceptance by the initiated party (i.e., buyer or seller), as shown in block 40. Provided the initiated party accepts the agreement (see block 42), the facilitator arrangement can provide, to the initiating party arrangement, confidential, access-restricted information related to the initiated party, as shown in block 44. The confidential information can be provided in any of a number of different manners, such as by forwarding the initiating party arrangement a password permitting the initiating party arrangement to access the confidential information. For example, the facilitator arrangement can permit a buyer arrangement to access confidential information comprising one or more pieces of seller information regarding the seller and/or the seller's property of interest to the buyer arrangement. The access-restricted seller information and buyer information can include any of a number of different pieces of information, including contact information for the seller and buyer, and one or more of the pieces of seller information and buyer information indicated above. However, at least a portion of the confidential information typically comprises information not having been included in the listings previously sent to the buyer arrangement and seller arrangement (see block 34).

Irrespective of the confidential information provided to the initiating party arrangement, once the initiating and initiated parties are engaged in communication, the parties can be restricted from contacting other parties (i.e., other sellers and buyers) for a predefined engagement period (e.g., five days). In this regard, the parties can be considered engaged in communication in any of a number of different manners. For example, the parties can be considered engaged in communication once the initiated party accepts the non-disclosure, non-circumvent agreement, or once the initiated party receives the password or uses the password to access information related to the initiated party, as shown in block 46. Irrespective of when the parties are considered engaged in communication, during the engagement period, the buyer can be restricted from communicating with other sellers regarding other properties. Likewise, the seller can be restricted from communicating with other buyers regarding the same property during the engagement period. The parties can be restricted from communicating with other parties in any of a number of different manners. For example, the facilitator can contractually restrict the parties from communicating with other parties. Additionally or alternatively, for example, the facilitator arrangement can remove, or otherwise restrict access to, the parties from the listings of properties and buyers sent to other buyer arrangements 12 and seller arrangements 14 (see block 34). Advantageously, restricting each party from communicating with other parties during the engagement period can facilitate the parties concluding a real estate transaction with one another without outside interference.

After the initiating and initiated parties are engaged in communication, the parties may desire to conclude a real estate transaction regarding a property of the seller. In such an instance, the parties can conclude the real estate transaction in any of a number of different manners, such as by entering into a sales contract regarding a respective property and closing on the respective property, shown in block 48. In such instances, the facilitator can operate outside the transaction, or alternatively function as a broker for the transaction. In another alternative, the facilitator can engage a broker, closing agent or other facilitator for the transaction, with the facilitator and the engaged party entering into a separate agreement related to the brokering of the transaction. In either event, at the conclusion of the transaction, such as during closing of the property, the facilitator can collect the predefined fee from the initiating party for the service provided by the facilitator, as shown in blocks 50 and 52. Also at the conclusion of the transaction, if so desired and previously offered by the facilitator, the facilitator can provide the buyer with a limited duration tenant default insurance policy, as shown in block 54 and explained below.

As explained above, the service offered by the facilitator arrangement 16 can provide, for a period of time, tenant default insurance to the buyer against loss of income due to default of the existing tenants of the property, should a buyer and seller conclude the purchase/sale of a property of the seller. In this regard, the facilitator arrangement can provide the buyer and seller of leasehold interest property the ability to insure income from that property against default of one or more tenants of that property under the terms of one or more leases held for that property at time of concluding the purchase/sale of the property. As will be appreciated, the facilitator can provide the insurance as a self-insurer. Additionally or alternatively, however, the facilitator can engage a fourth party, such as an insurance carrier, to provide all or a portion of the insurance through the fourth party or in conjunction with underwriting of the fourth party.

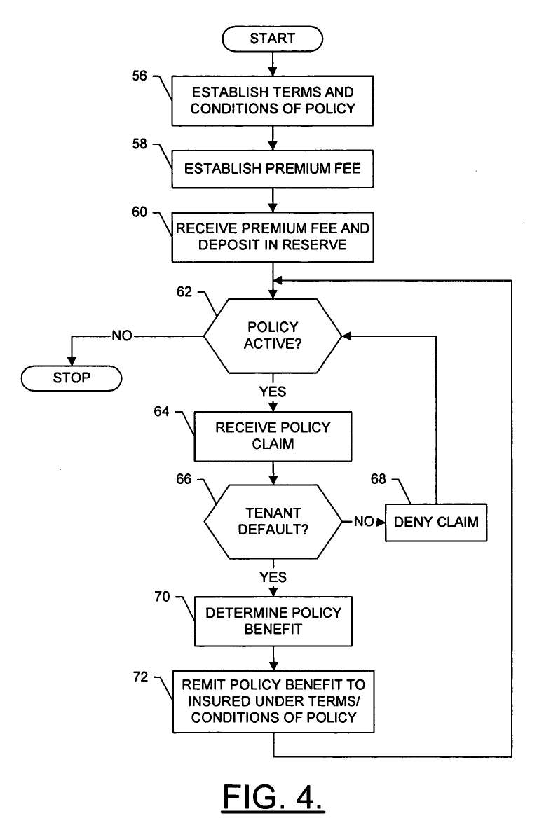

Reference is now made to FIG. 4, which illustrates various steps in a method of insuring the owner or leaseholder of income-producing property against the default of one or more tenants of such property, the property being referred to herein as the “insured property.” As shown in block 56, the method includes the facilitator arrangement 16 establishing the terms and conditions of an insurance policy under which the facilitator arrangement intends to insure the buyer or new owner of the insured property, who is also typically the leaseholder of one or more leases for the insured property or portions thereof (the buyer, owner, leaseholder also referred to herein as the “insured party”). The terms and conditions can include any of a number of different terms and conditions specific to the protection provided by the insurance policy, and if so desired, can include one or more terms and/or conditions typically offered under conventional insurance policies.

For example, the terms and conditions of the insurance policy can include a time period over which the policy is active, as well as define default of a tenant for which the policy covers loss of income. Default of a tenant can be defined in a number of different manners, such as in accordance with one of more provisions of the lease entered into by the tenant with respect to the insured property. More particularly, for example, the default of a tenant can be defined in accordance with provision(s) of the lease that relate to the financial inability of the tenant to pay rent under the terms of the lease. If so desired, default can also be defined based upon tenant holdover or occupancy during a period in which the tenant is not paying all or a portion of the rents due under the terms of the lease, against the will of the leaseholder. However, default is typically not based upon acts of God, construction delays and/or interruption of occupancy reason.

In addition to defining default of a tenant, the terms and conditions established by the facilitator arrangement 16 can include different levels of tenant default insurance, typically in accordance with a review of the financial status of the property tenancy. The levels of tenant default insurance can vary in any of a number of different manners. In this regard, the facilitator arrangement can provide tenant default insurance that covers all or a portion of the tenants of the insured property, where the covered tenant(s) may or may not be specified. Also, the facilitator arrangement can provide tenant default insurance that varies based upon the length and breadth of income protection coverage, and the percentage of income protection. The percentage of income protection, which can also correspond to the total liability or exposure of the facilitator arrangement in providing the insurance, can be determined in any of a number of different manners. In one embodiment, for example, the percentage of income protection is based upon the net operating income (NOI) of the insured property at the conclusion of the transaction. As an example, then, the facilitator arrangement can provide coverage ranging from 1% to 100% of the NOI, extending for the first twenty-four months of ownership (two years from transaction conclusion), and guaranteeing income for twelve months at any time during the first twenty-four months.

In addition, for example, the terms and conditions established by the facilitator arrangement 16 can require the insured party to evict a defaulting tenant, typically for non-payment of rent. Further, the terms and conditions can include a number of rights reserved by the facilitator arrangement with respect to the insured party, and/or the insured property. For example, the terms and conditions can include rights reserved by the facilitator arrangement such as the right to (a) re-lease and or be paid to re-lease the vacated, insured property or portion thereof immediately upon tenant default, (b) insure only the leasehold interest in place at time of property acquisition by the insured party, (c) determine the time, time period and extent of coverage, (d) refuse to offer or discontinue service or coverage under the policy for any reason, (e) to offer coverage for any property for which there is a leasehold interest created, (f) offer this service on all or a portion of the tenancy of a given property, (g) sue for damages and expenses if the facilitator arrangement determines that the default was unnecessarily constructed for the financial gain of tenant and/or insured party, (h) deny coverage if the tenant and insured party are related, in business together, have any financial gain to or from each other as a result of tenant default, or tenant and/or leaseholder conspire or collude with any third party for the benefit of leaseholder or tenant, (i) increase, extend or modify our service or coverage on all or a part of any leasehold protection offered by the facilitator arrangement, at the sole discretion of the facilitator arrangement, (j) extend coverage through third party sources at the sole discretion of the facilitator arrangement, (k) offer coverage directly or subcontract such coverage for a fee to any legally qualified second or third party at the sole discretion of the facilitator arrangement, (l) legally offer coverage domestically or internationally, (m) terminate coverage with any secondary provider for any reason and reassign such right of coverage to another legally capable party or offer coverage directly, (n) franchise or contract with other companies to legally provide service under the policy, (o) offer service or coverage under the policy under different names in different forms, and/or (p) offer service under the policy to any leasehold interest property through various delivery mediums including the Internet (i.e., network 18).

Before, as or after the facilitator arrangement 16 establishes the terms and conditions of the insurance policy, the facilitator arrangement can establish a premium fee for providing the insurance policy, as shown in block 58. The premium fee can be established in any of a number of different manners. For example, the premium fee can be established based upon the sales price, or open market value, of the insured property.

However, to provide benefit to the insured party, the premium fee is typically less than the total coverage provided by the insurance policy. In this regard, see Table 1 below for a sampling of ten exemplar properties sold and insured in accordance with embodiments of the present invention.

TABLE 1

| | | | Premium | | Actuarial |
|---|---|---|---|---|---|
| | CAP | | Fee | Exposure | Exposure |
| NOI ($) | Rate | Sale Price ($) | (0.5%) ($) | ($) | (3%) ($) |
| 500,000 | 10 | 5,000,000 | 25,000 | 75,000 | |
| 2,000,000 | 8 | 25,000,000 | 125,000 | 300,000 | |
| 750,000 | 9 | 8,333,333 | 41,500 | 112,500 | |
| 1,000,000 | 9 | 11,111,111 | 56,000 | 150,000 | |
| 600,000 | 9 | 6,667,000 | 34,000 | 90,000 | |
| 800,000 | 9 | 8,889,000 | 44,000 | 120,000 | |
| 500,000 | 10 | 5,000,000 | 25,000 | 75,000 | |
| 950,000 | 8 | 11,875,000 | 60,000 | 142,500 | |
| 3,500,000 | 7 | 50,000,000 | 250,000 | 525,000 | |
| 1,500,000 | 8 | 18,750,000 | 93,750 | 225,000 | |
| 12,100,000 | | 150,625,444 | 754,250 | 1,815,000 | 363,000 |

As shown in Table 1, presuming coverage of 15% of the NOI and a premium of 0.5% the sales price, the premium can equal approximately one-third of the total coverage provided by the insurance policy, which also corresponds to the total liability or exposure of the facilitator arrangement 16. Although the premium fee is typically less than the total coverage (total exposure) provided by the insurance policy, the actuarial exposure of the facilitator arrangement, or the more likely exposure of the facilitator arrangement, is typically less than the premium fee. To offset the total exposure, or more particularly the total actual exposure, then, the facilitator arrangement can reinsure the actuarial exposure of the facilitator arrangement, such as with a fourth party insurance carrier. However, if during the period of the insurance policy the facilitator arrangement determines the level of insurance with the fourth party insurance carrier does or will not adequately cover the exposure of the facilitator arrangement, the facilitator arrangement can adjust the level of coverage with the fourth party insurance carrier accordingly.

The actuarial exposure of the facilitator arrangement 16 can be estimated or otherwise determined in any one of a number of different manners. For example, the actuarial exposure can be estimated based upon the historical tenant default rate of the insured property over the duration of ownership of the insured property, and the NOI of the insured property. As will be appreciated, different properties have different historical tenant default rates over the duration of ownership of the respective properties. For example, retail, office and industrial properties historically have had a 7% default rate due to tenant vacancy and credit loss (i.e., default). But since the tenant default insurance is typically only based upon tenant default, the historical default rate can be estimated to be approximately half or less than half of the total historical default rate. Thus, for example, for retail, office and industrial properties, the actuarial tenant default rate can be estimated to equal approximately 3% or less. Thus, for retail, office and industrial properties, the actuarial exposure of the facilitator arrangement can be estimated to equal 3% of the NOI of the respective properties. As shown from Table 1, then, the actuarial exposure of the facilitator arrangement can be estimated to equal approximately $363,000 (i.e., 3% of 12,100,000), which is less than the premium fee of $754,250, which is less than the total coverage or total actual exposure of the facilitator arrangement, i.e., $1,815,000.

Irrespective of how the premium fee is established, the facilitator arrangement can thereafter receive the established premium fee from the insured party, such as the buyer arrangement 12 and/or the seller arrangement 14, and deposit that premium fee in reserve, as shown in block 60. In one typical embodiment where the insurance policy is offered in conjunction with the sale of property, the premium fee can be received by reserving a percentage (e.g., 0.5%) of the predefined fee received from the initiating party at the conclusion of a real estate transaction between the buyer arrangement and the seller arrangement. Alternatively, the premium fee can be received from the insured party independent of a real estate transaction. In such an instance, the insured party may operate as an owner or leaseholder of the insured property. In either event, the facilitator can deposit the percentage of the predetermined fee or additional fee (i.e., the premium fee) with a fourth party, such in a reserve account of a bank.

As or after receiving and depositing the premium fee, and while the policy is active (block 62), the insured party (e.g., buyer arrangement 12) may at one or more times receive notice that one or more tenants of the insured property have defaulted on paying rent under the terms of their lease under the terms of the policy. The insured party can receive notice in any of a number of different manners, such as by receiving notice of default directly from the tenant, and/or failure to receive a periodic (e.g., monthly) rental payment from the tenant. In such an instance, the insured party can notify the facilitator arrangement 16 of the tenant default, such as by filing an insurance claim with the facilitator arrangement, as shown in block 64. As will be appreciated, the insurance claim can include any of a number of different pieces of information including, for example, the identity of the defaulting tenant, rental income due to the insured party from the defaulting tenant, the remaining term of the defaulting tenant's lease or the like.

After receiving notification of the tenant default, the facilitator arrangement 16 can determine if the tenant has defaulted under the terms and conditions of the insurance policy, as shown in block 66. If the tenant has not defaulted under the terms and conditions of the insurance policy, the facilitator arrangement can deny the insurance claim of the insured party or otherwise refuse to remit a policy benefit to the insured party (e.g., buyer arrangement 12), as shown in block 68. Otherwise, if the tenant has defaulted under the terms and conditions of the insurance policy, the facilitator arrangement can determine a policy benefit payable to the insured party, also under the terms and conditions of the insurance policy, as shown in block 70. The policy benefit can be determined in any of a number of different manners in accordance with the terms and conditions of the insurance policy. In one typical embodiment, for example, the policy benefit can be determined based upon the rental income due the insured party from the defaulting tenant. For example, presume the insurance policy provides coverage of up to 15% of the NOI of the insured property. In such an instance, the policy benefit can be determined as 15% of the rental income due the insured party from the defaulting tenant under, less expenses incurred by the insured party in renting the respective portion of the property to the defaulting tenant. Alternatively, the policy benefit can be determined as 15% of the difference of the NOI of the property due the insured party with the defaulting tenant and the NOI without the defaulting tenant, where the NOI can be determined based upon the periodicity with which the defaulting tenant is due rent (e.g., monthly NOI of the insured property).

After determining the policy benefit, the facilitator arrangement 16 can remit the policy benefit to the insured party (e.g., buyer arrangement 12) under the terms and conditions of the policy, such as via check, bank draft, electronic wire transfer or the like, as shown in block 72. The method can then continue for the respective tenant, such as until the active time period of the policy expires or the portion of the insured property previously occupied by the respective defaulting tenant is occupied by a new tenant. In this regard, although the defaulting tenant may be evicted from the insured property, the tenant may still be considered in default and thus resulting in a loss of income. In continuing the method, the facilitator arrangement can repeatedly determine if the respective tenant remains in default under the terms and conditions of the policy (see block 64), such as with the same periodicity (e.g., monthly) with which the respective tenant paid rent. Additionally, the facilitator arrangement can repeatedly determine the policy benefit and/or remitting the policy benefit to the insured party, such as with the respective periodicity. In any event, however, the facilitator arrangement typically does not determine if the respective tenant is in default, determine or remit the policy benefit after the time period of the policy expires, or after the portion of the insured property previously occupied by the respective defaulting tenant is occupied by a new tenant.

As will be appreciated, the policy can be applied to more than one tenant of the insured property, if in accordance with the terms and conditions of the policy. More particularly, the insured property may include more than one tenant that at any given time during the time period of the policy, may default. For each tenant covered under the policy, then, the facilitator arrangement 16 can receive notification of the tenant default (see block 64), determine if the tenant has defaulted under the terms and conditions of the insurance policy (see block 66), and if the tenant has defaulted, determine and remit a policy benefit to the insured party (see blocks 70 and 72).

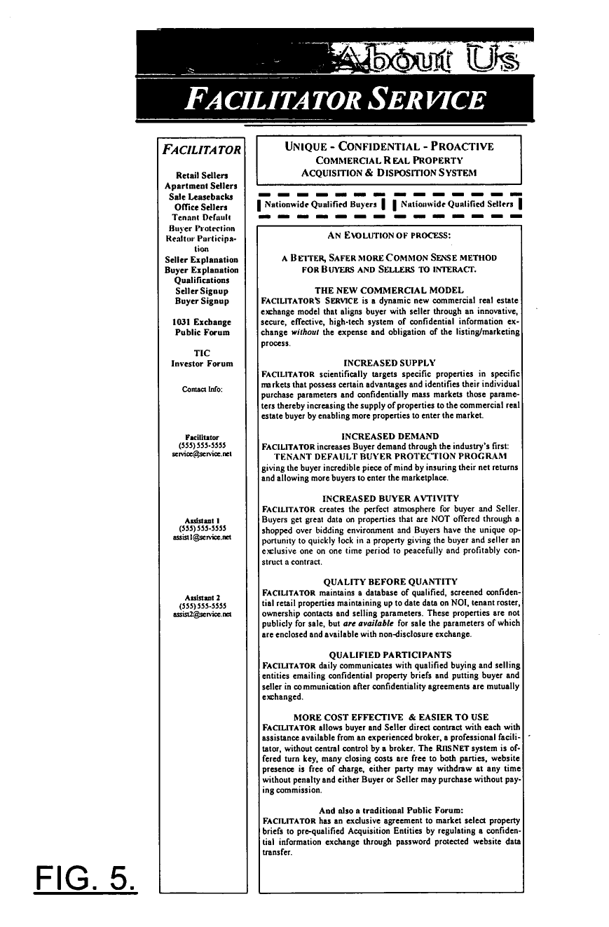

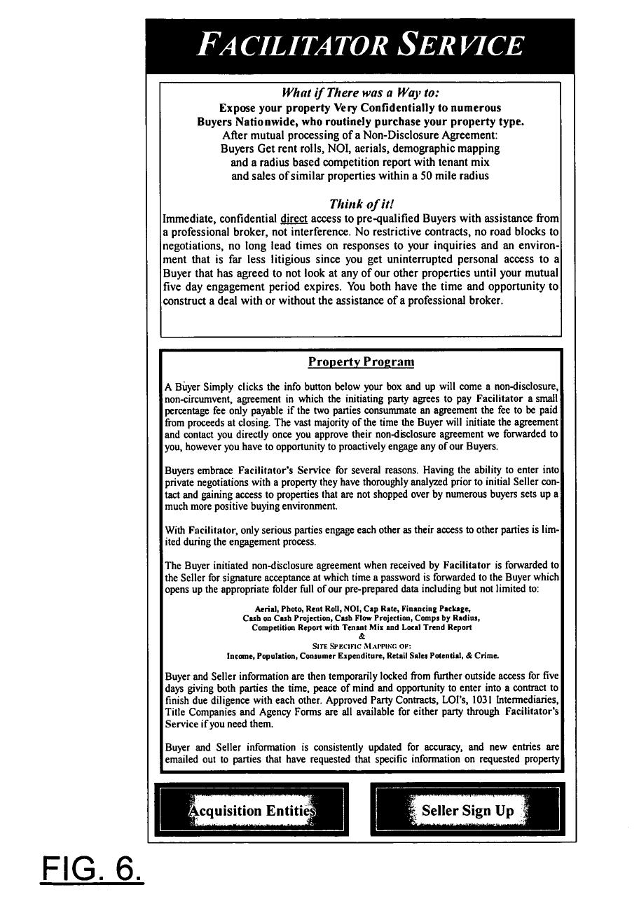

To further illustrate the benefits of the present invention, reference is now made to FIGS. 5-19, which illustrate exemplar displays, such as Web pages, capable of being provided by the facilitator arrangement 16 to the buyer arrangement 12 and/or seller arrangement. In this regard, the displays may be provided across the Internet (e.g., network 18), and thereafter presented by the respective arrangement for display to the buyer and/or seller. More particularly, as shown in FIG. 5, the facilitator arrangement can provide a portal that can explain the service offered by the facilitator arrangement, and include a number of links to other displays that permit the buyer arrangement and/or seller arrangement to engage the service. For example, the display of FIG. 5 can include a link to “Seller Explanation,” a “Buyer Explanation” and a “Program Qualifications” displays, which direct the facilitator arrangement to provide the displays of FIGS. 6, 7 and 8, respectively.

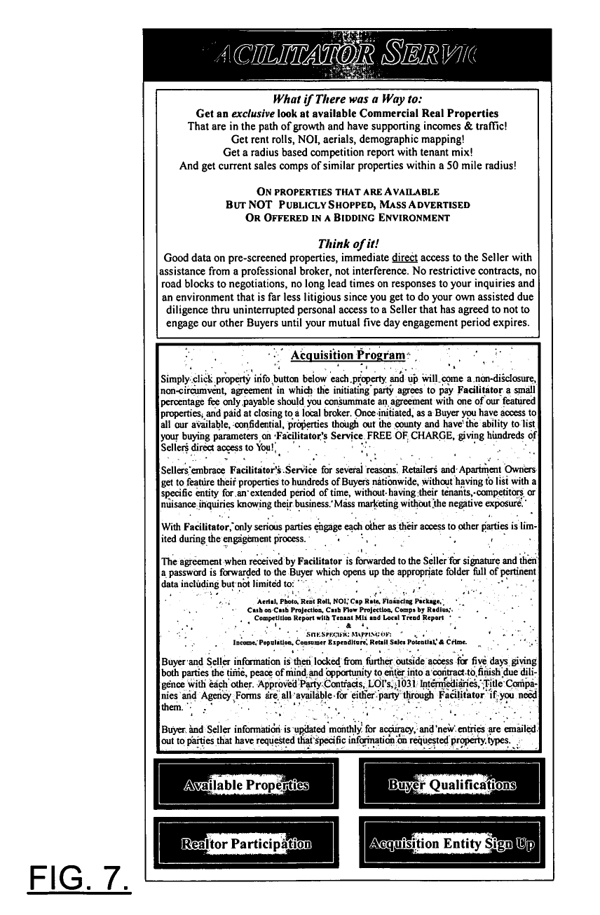

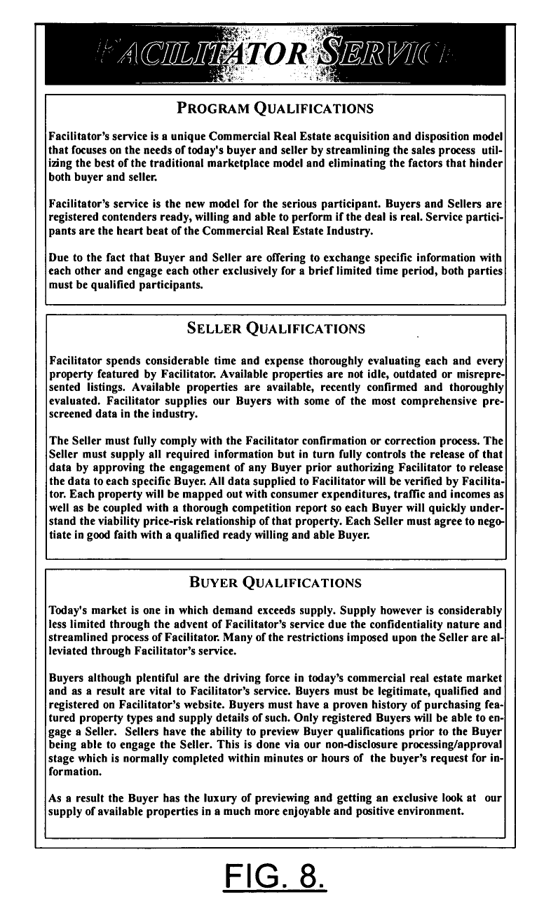

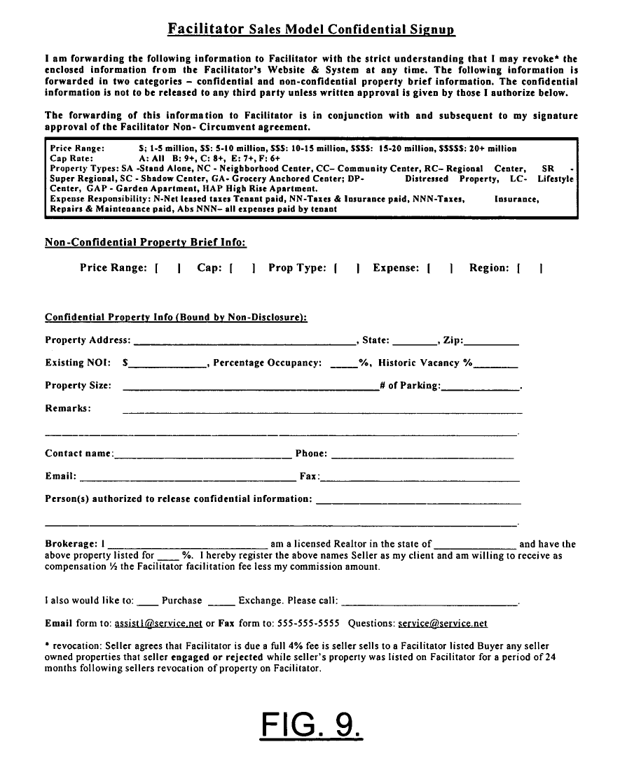

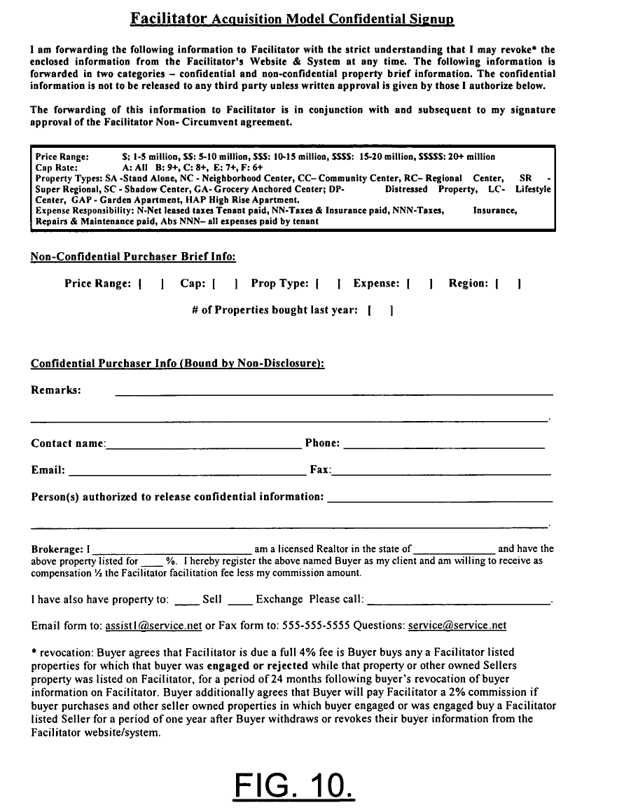

FIG. 6, then, illustrates a display that explains the service offered by the facilitator arrangement 16 to seller arrangements 14, and FIG. 7 illustrates a display that explains the service offered to buyer arrangements 12. FIG. 8, on the other hand, illustrates a display that explains the qualifications of the program or service, as well as that of seller arrangements and buyer arrangements participating in the program or service. In addition, the displays of FIGS. 6 and 7, as well as the portal display of FIG. 5, can include a link to permit a seller arrangement or a buyer arrangement to register with the facilitator arrangement, or more particularly with the service offered by the facilitator arrangement (see block 32 of FIG. 3A). Should a seller arrangement or buyer arrangement desire to register with the service, the seller arrangement or buyer arrangement can execute a respective link, which can direct the facilitator arrangement to provide the sign-up form displays of FIGS. 9 and 10, respectively. As shown in FIGS. 9 and 10, the seller arrangements and buyer arrangements can provide the facilitator arrangement with information regarding the properties of the sellers and/or the sellers themselves, or information regarding the buyers can be generated, gathered or otherwise received by the facilitator arrangement. As indicated above, after the facilitator arrangement 16 receives the buyer information or the seller information, the facilitator arrangement can evaluate the information to at least partially ensure that the buyers are legitimate and qualified to purchase an indicated level of real estate, or to allow the facilitator arrangement to provide data related to the properties of the sellers.

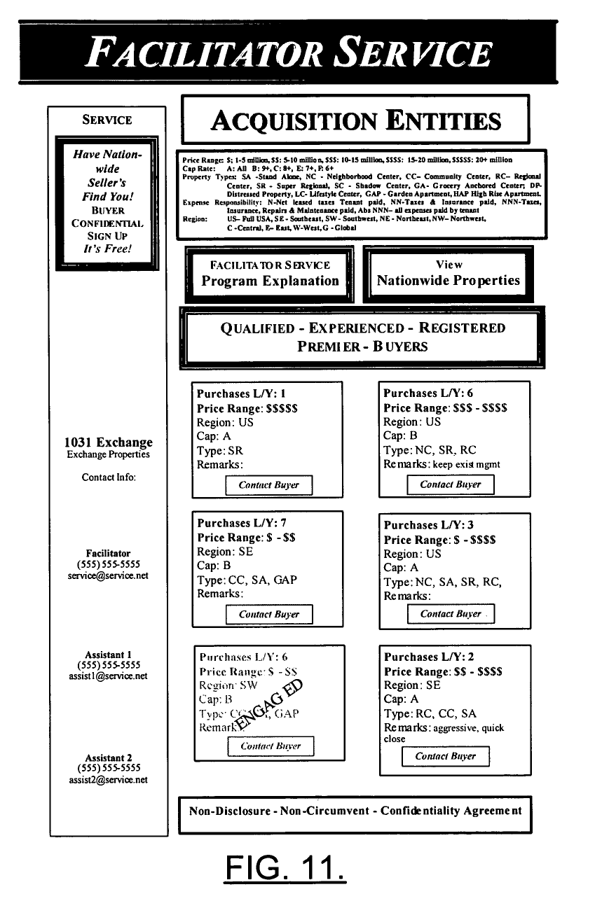

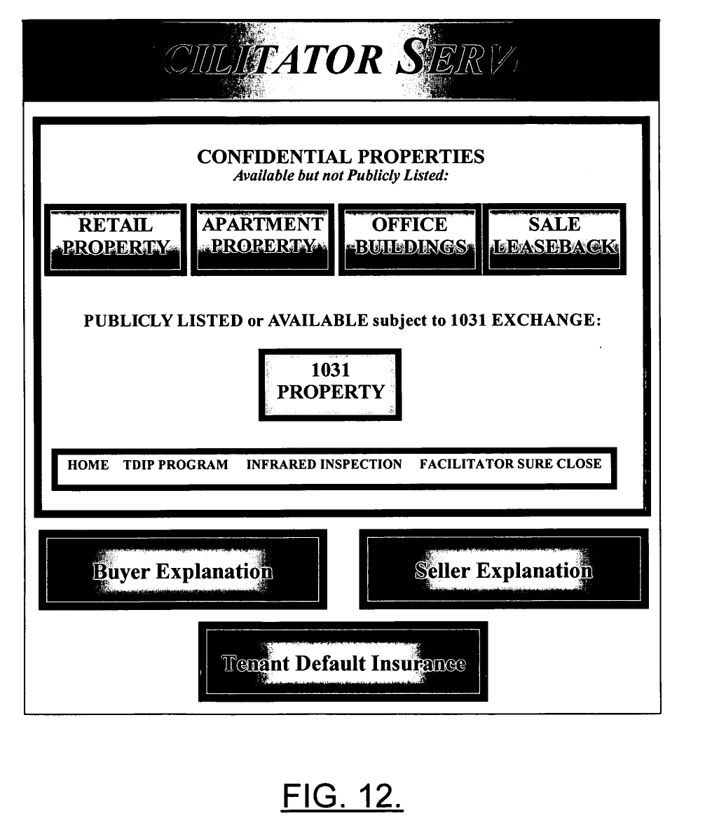

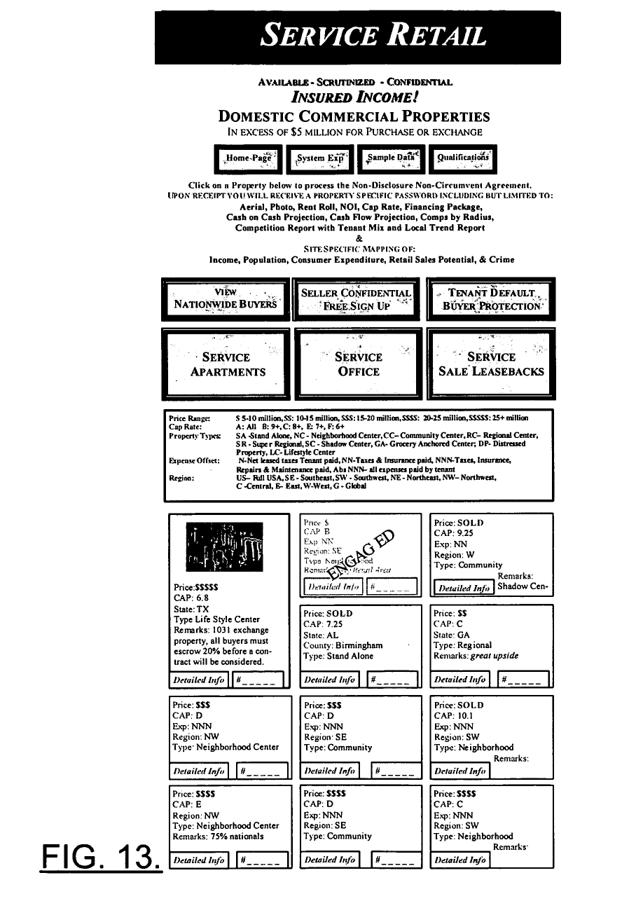

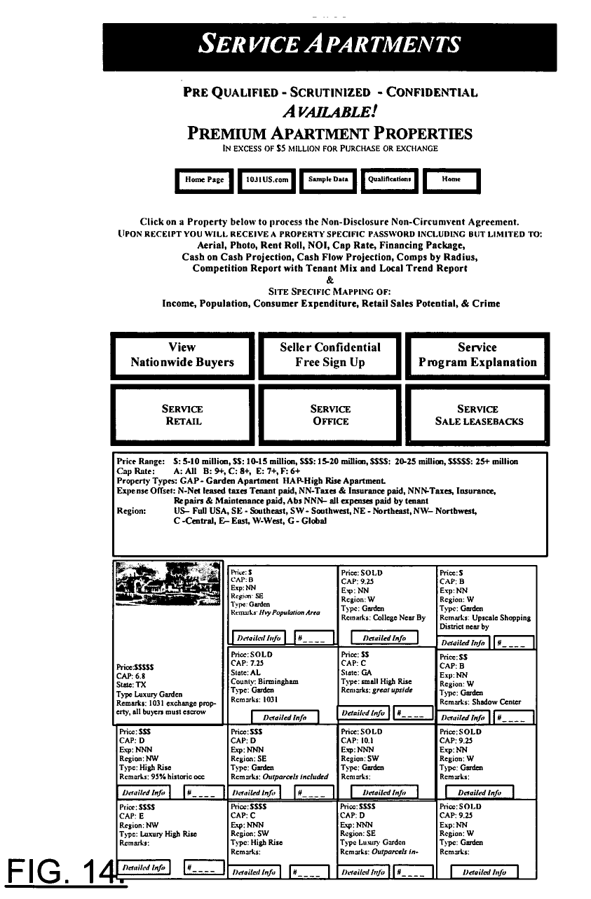

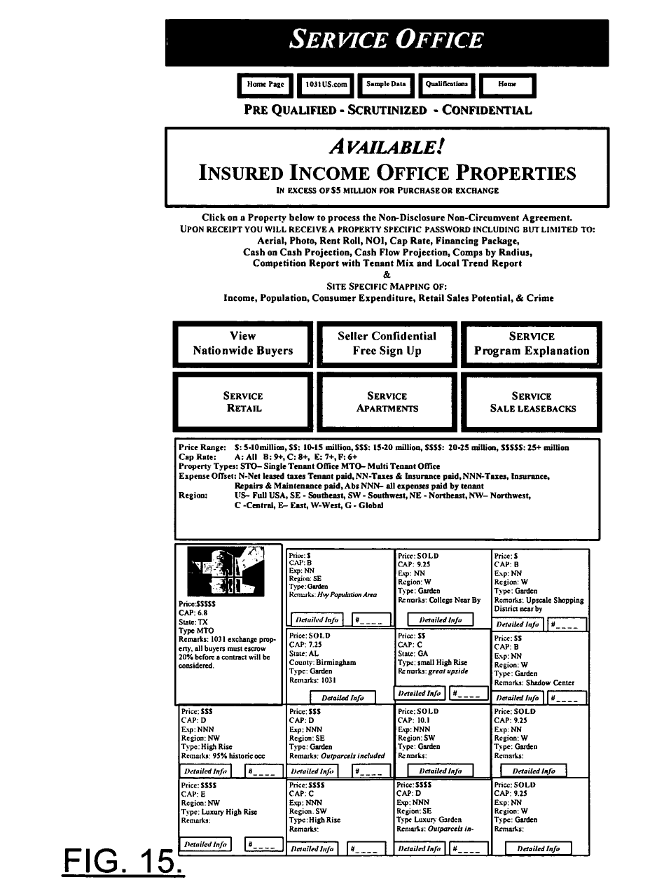

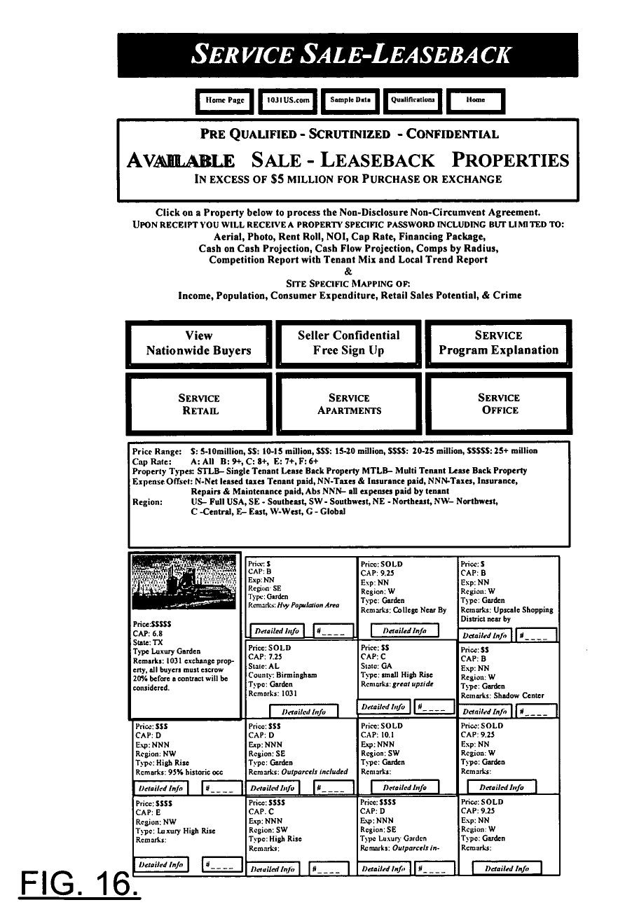

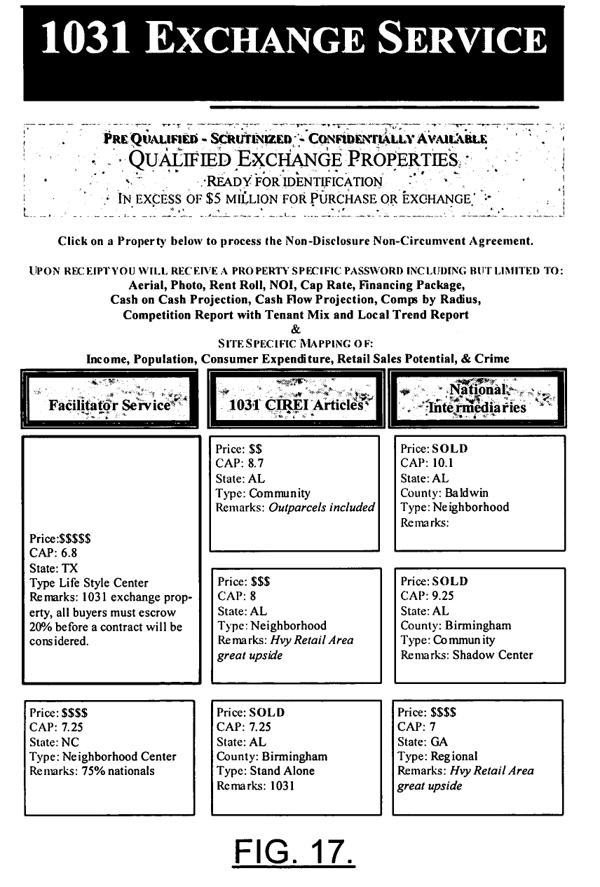

For buyer arrangements 12 and seller arrangements 14 registered with the service provided by the facilitator arrangement 16, as well as buyer and seller arrangements not registered with the service (if so desired), the facilitator arrangement provide listings of buyers and properties (see block 34 of FIG. 3A). More particularly, as shown in FIG. 11, the facilitator arrangement can provide a display of acquisition entities (i.e., buyers), including a portion of the buyer information stored in the buyer database, the buyer information being sufficient to allow sellers to gauge an interest in the buyers. As shown in FIG. 12, the facilitator arrangement can provide a portal to listings of confidential retail, apartment, office and sale-leaseback properties, as well as publicly listed or available properties subject to IRS 1031 tax deferred exchange. From the portal of listings (as well as the portal of FIG. 5), the facilitator arrangement can provide displays of retail properties (FIG. 13), apartment properties (FIG. 14), office properties (FIG. 15), sale-leaseback properties (FIG. 16) and/or 1031 properties (FIG. 17). Within each display, then, the facilitator arrangement can include a listing of respective properties, as well as a portion of the seller information stored in the property database, the portion of the information being sufficient to allow buyers to gauge an interest in the properties.

From the respective listings, the buyer arrangements 12 can identify properties of interest, and the sellers can identify buyer arrangements of interest (see block 36 of FIG. 3A). Then, as explained above, an initiating party (i.e., buyer or seller) desires to contact an initiated party (i.e., seller or buyer), the initiating party can receive from the facilitator arrangement 16, and thereafter execute, a the non-disclosure, non-circumvent facilitation agreement. Then, after the initiated party has accepted the agreement, the facilitator arrangement can provide, to the initiating party arrangement, confidential, access-restricted information related to the initiated party (see blocks 38-44 of FIG. 3A).

Once the initiating and initiated parties are engaged in communication, the parties can be restricted from contacting other parties (i.e., other sellers and buyers) for a predefined engagement period (e.g., five days). For example, the facilitator arrangement 16 can restrict access to the buyer arrangement 14 and the respective property of the seller arrangement 14 from the listings of buyers and properties. In this regard, the facilitator arrangement can restrict access to the buyer arrangement by blanking out the entry for the buyer in the display of buyers and identifying the buyer as being “Engaged,” shown in FIG. 11. Similarly, the facilitator arrangement can restrict access to the respective property by blanking out the entry for the property in the display of properties and identifying the property as being “Engaged,” shown in FIG. 12. As indicated above, by restricting each party from communicating with other parties during the engagement period, the facilitator arrangement can facilitate the parties concluding a real estate transaction with one another without outside interference.

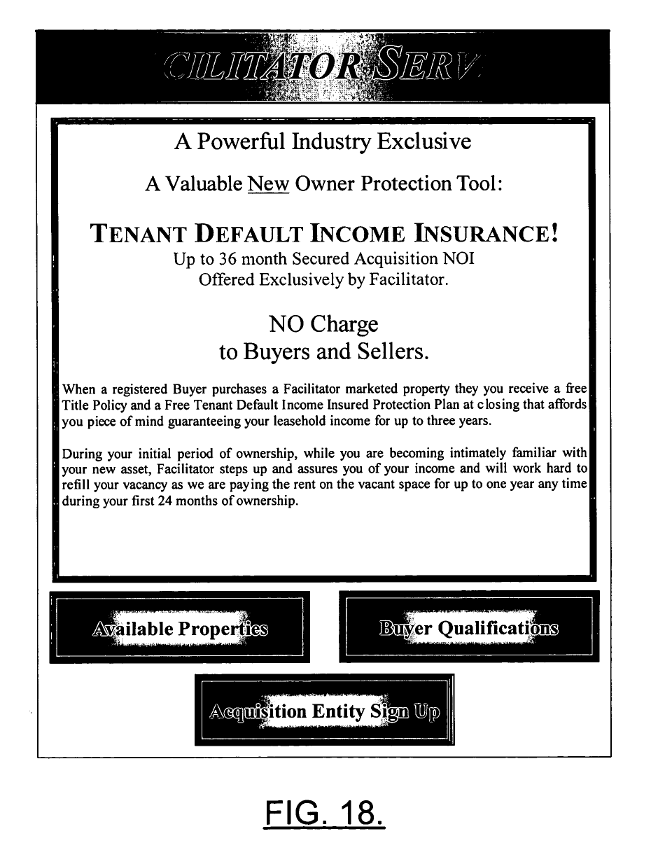

After the initiating and initiated parties are engaged in communication, if the parties can conclude the real estate transaction for the respective property (see block 48), the facilitator can collect a predefined fee from the initiating party for the service provided by the facilitator (see blocks 50 and 52). Also at the conclusion of the transaction, if so desired and previously offered by the facilitator, the facilitator can provide the buyer with a limited duration tenant default insurance policy (see block 54). In this regard, as the buyer arrangements 12 and seller arrangements 14 engage the service offered by the facilitator arrangement 16, the facilitator arrangement can provide the buyer arrangements and seller arrangements with information regarding such a policy, as shown in the display of FIG. 18. And by providing such information, the facilitator arrangement can facilitate the buyer arrangements and seller arrangements registering with the service offered by the facilitator arrangement, and concluding a transaction while engaging the service.

As will be appreciated, the service of the facilitator arrangement 16 described herein can be provided in a number of different contexts relating to real estate, from commercial to residential real estate. It should be understood, however, that the service can generally be provided in any of a number of different contexts involving a buyer and a seller of a good. For example, the service can be provided by the facilitator arrangement in the context of an auction offering of a good by a seller to a number of buyers, such as in the context of an online auction (e.g., eBay).

Also, the tenant default insurance described herein can be provided in conjunction with a real estate transaction between a buyer arrangement 12 and a seller arrangement 14. It should be understood, however, that the tenant default insurance can be provided independent of such a transaction, without departing from the spirit and scope of the present invention. For example, the tenant default insurance can be provided to a buyer arrangement independent of the transaction between the buyer and a seller of a respective property. Alternatively, for example, the tenant default insurance can be provided to an owner of a property at any point during the ownership tenure of the owner. Also, it should be understood that the tenant default insurance can also be provided in conjunction with other investment tools such as tenant-in-common ownership, REIT (real estate investment trust) ownership and/or IRS 1031 tax deferred exchange programs to create a new investment vehicle that offers a guarantee of a certain level of income to the new buyer during initial ownership, or during a period extending beyond initial ownership, if so provided by the facilitator arrangement.

According to one aspect of the present invention, all or a portion of the system of the present invention, such as all or portions of the buyer arrangement 12, seller arrangement 14 and/or facilitator arrangement 16, generally operates under control of a computer program product. The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIGS. 3A, 3B and 4 are flowcharts of methods, systems and program products according to the invention. It will be understood that each block or step of the flowcharts, and combinations of blocks in the flowcharts, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowcharts. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowcharts. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowcharts.

Accordingly, blocks or steps of the control flow diagrams support combinations of means for performing the specified functions, combinations of steps for performing the specified functions and program instruction means for performing the specified functions. It will also be understood that each block or step of the flowcharts, and combinations of blocks or steps in the flowcharts, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for insuring an entity with respect to an income-producing property including at least one tenant expected to pay rent to the party, the system comprising:
a facilitator arrangement capable of providing a policy to an entity, the policy defining a default of at least one tenant of the property based upon a financial inability of at least one tenant to pay rent to the entity, and wherein the facilitator arrangement is capable of insuring the entity under the policy, the entity being insured against loss of a income due to default of at least one tenant of the property.

2. A system according to claim 1, wherein the facilitator arrangement is capable of providing a policy that also defines a level of protection, the level of protection having been determined based upon a percentage of an income received by the entity from the property.

3. A system according to claim 2, wherein the facilitator arrangement is capable of providing a policy that defines a level of protection comprising a percentage of a net operating income (NOI) received by the entity from the property.

4. A system according to claim 1, wherein the facilitator arrangement is capable of insuring the entity by determining a policy benefit, and thereafter remitting the policy benefit to the entity if a tenant defaults under the policy.

5. A system according to claim 4, wherein the facilitator arrangement is capable of determining a policy benefit based upon a rental income due the entity from the defaulting tenant.

6. A system according to claim 5, wherein the facilitator arrangement is capable of determining a policy benefit based upon an income due the entity from the property before the tenant defaults, and an income due the entity from the property after the tenant defaults, and wherein the income due the entity from the property before and after the tenant defaults is at least partially based upon the rental income due the entity from the defaulting tenant.

7. A system according to claim 1, wherein the entity comprises a buyer arrangement, wherein the facilitator arrangement is also capable of engaging an initiating party in communication with an initiated party regarding the property, wherein the initiating party comprises one of the buyer arrangement and a seller arrangement, and the initiated party comprises the other of the buyer arrangement and the seller arrangement, and
wherein the facilitator arrangement is capable of providing the policy and insuring the entity after the parties conclude a real estate transaction regarding the property.

8. A system according to claim 7, wherein the facilitator arrangement is capable of engaging the parties for an engagement period, wherein the facilitator arrangement is further capable of restricting the engaged parties from communicating with other parties during the engagement period, the other parties comprising at least one of at least one other buyer arrangement and at least one other seller arrangement, and wherein restricting the engaged parties comprises restricting the engaged parties to thereby facilitate the parties concluding a real estate transaction regarding the property.

9. A system according to claim 8, wherein the facilitator arrangement is capable of providing at least one of a buyer listing and a property listing, wherein the buyer listing includes at least one buyer arrangement, and the property listing includes at least one property of at least one seller arrangement, wherein one of the listings includes the initiating party and the other listing includes the initiated party, and wherein the facilitator arrangement is also capable of receiving a selection of an initiated party from one of the listings before engaging the parties in communication, the initiated party being selected by the initiating party.

10. A system according to claim 9, wherein the facilitator arrangement is capable of restricting the engaged parties from communicating by restricting access to the initiating party in the respective listing including the initiating party, and restricting access to the initiated party in the respective listing including the initiated party.

11. An insurance system comprising:
an entity associated with an income-producing property including at least one tenant expected to pay rent to the entity; and
a facilitator arrangement capable of insuring the entity against loss of a income due to a default of at least one tenant of the property, the default of at least one tenant comprising a financial inability of at least one tenant to pay rent to the entity.

12. An insurance system according to claim 11, wherein the facilitator arrangement is capable of insuring the entity with a level of protection, the level of protection having been determined based upon a percentage of an income received by the entity from the property.

13. An insurance system according to claim 12, wherein the facilitator arrangement is capable of insuring the entity with a level of protection comprising a percentage of a net operating income (NOI) received by the entity from the property.

14. An insurance system according to claim 11, wherein the facilitator arrangement is capable of insuring the entity by determining an insurance benefit, and thereafter remitting the insurance benefit to the entity if a tenant defaults.

15. An insurance system according to claim 14, wherein the facilitator arrangement is capable of determining a insurance benefit based upon a rental income due the entity from the defaulting tenant.

16. An insurance system according to claim 15, wherein the facilitator arrangement is capable of determining a insurance benefit based upon an income due the entity from the property before the tenant defaults, and an income due the entity from the property after the tenant defaults, and wherein the income due the entity from the property before and after the tenant defaults is at least partially based upon the rental income due the entity from the defaulting tenant.

17. An insurance system according to claim 11, wherein the entity comprises a buyer arrangement, wherein the facilitator arrangement is also capable of engaging an initiating party in communication with an initiated party regarding the property, wherein the initiating party comprises one of the buyer arrangement and a seller arrangement, and the initiated party comprises the other of the buyer arrangement and the seller arrangement, and
wherein the facilitator arrangement is capable of insuring the entity after the parties conclude a real estate transaction regarding the property.

18. An insurance system according to claim 17, wherein the facilitator arrangement is capable of engaging the parties for an engagement period, and wherein the facilitator arrangement is further capable of restricting the engaged parties from communicating with other parties during the engagement period, the other parties comprising at least one of at least one other buyer arrangement and at least one other seller arrangement, and wherein restricting the engaged parties comprises restricting the engaged parties to thereby facilitate the parties concluding a real estate transaction regarding the property.

19. An insurance system according to claim 18, wherein the facilitator arrangement is capable of providing at least one of a buyer listing and a property listing, wherein the buyer listing includes at least one buyer arrangement, and the property listing includes at least one property of at least one seller arrangement, wherein one of the listings includes the initiating party and the other listing includes the initiated party, and wherein the facilitator arrangement is also capable of receiving a selection of an initiated party from one of the listings before engaging the parties in communication, the initiated party being selected by the initiating party.

20. An insurance system according to claim 19, wherein the facilitator arrangement is capable of restricting the engaged parties from communicating by restricting access to the initiating party in the respective listing including the initiating party, and restricting access to the initiated party in the respective listing including the initiated party.

21. A method for insuring an entity with respect to an income-producing property including at least one tenant expected to pay rent to the entity, the method comprising:
providing a policy to an entity, the policy defining a default of at least one tenant of the property based upon a financial inability of at least one tenant to pay rent to the entity; and
insuring the entity under the policy, the entity being insured against loss of a income due to default of at least one tenant of the property.

22. A method according to claim 21, wherein providing a policy comprises providing a policy that also defines a level of protection, the level of protection having been determined based upon a percentage of an income received by the entity from the property.

23. A method according to claim 22, wherein providing a policy that also defines a level of protection comprises providing a policy that defines a level of protection comprising a percentage of a net operating income (NOI) received by the entity from the property.

24. A method according to claim 21, wherein insuring the entity under the policy comprises:
determining a policy benefit; and
remitting the policy benefit to the entity, and wherein determining a policy benefit and remitting the policy benefit occur if a tenant defaults under the policy.

25. A method according to claim 24, wherein determining a policy benefit comprises determining a policy benefit based upon a rental income due the entity from the defaulting tenant.

26. A method according to claim 25, wherein determining a policy benefit comprises determining a policy benefit based upon an income due the entity from the property before the tenant defaults, and an income due the entity from the property after the tenant defaults, and wherein the income due the entity from the property before and after the tenant defaults is at least partially based upon the rental income due the entity from the defaulting tenant.

27. A method according to claim 21, wherein the entity comprises a buyer arrangement, wherein the method further comprises:
engaging an initiating party in communication with an initiated party regarding the property, wherein the initiating party comprises one of the buyer arrangement and a seller arrangement, and the initiated party comprises the other of the buyer arrangement and the seller arrangement, and
wherein providing a policy and insuring the entity occur after the parties conclude a real estate transaction regarding the property.

28. A method according to claim 27, wherein engaging the parties comprises engaging the parties for an engagement period, and wherein the method further comprises:
restricting the engaged parties from communicating with other parties during the engagement period, the other parties comprising at least one of at least one other buyer arrangement and at least one other seller arrangement, wherein restricting the engaged parties comprises restricting the engaged parties to thereby facilitate the parties concluding a real estate transaction regarding the property.

29. A method according to claim 28 further comprising:
providing at least one of a buyer listing and a property listing, wherein the buyer listing includes at least one buyer arrangement, and the property listing includes at least one property of at least one seller arrangement, wherein one of the listings includes the initiating party and the other listing includes the initiated party; and
receiving a selection of an initiated party from one of the listings, the initiated party being selected by the initiating party,
wherein providing at least one of the listings and receiving a selection of an initiated party occur before engaging the parties in communication.

30. A method according to claim 29, wherein restricting the engaged parties from communicating comprises restricting access to the initiating party in the respective listing including the initiating party, and restricting access to the initiated party in the respective listing including the initiated party.
